(19) United States
(12) Patent Application Publication
(10) Pub. No.: US 2023/0381840 A1
(43) Pub. Date: Nov. 30, 2023

(54) ON-SITE PROCESSING OF SCRAP DRYWALL FOR FACILITATING REMOVAL, TRANSPORTATION, AND RECYCLING

(71) Applicant: Bryan A. Diffley, Pelham, NY (US)

(72) Inventor: Bryan A. Diffley, Pelham, NY (US)

(21) Appl. No.: 18/324,466

(22) Filed: May 26, 2023

Related U.S. Application Data
(60) Provisional application No. 63/365,440, filed on May 27, 2022.

(51) Int. Cl. B09B 3/35; C04B 18/167

(52) U.S. Cl. CPC B09B 3/35; C04B 18/167; B09B 2101/25

(57) ABSTRACT

Methods and systems for processing and recycling drywall are described herein. A mobile dry wall processor may be used at a construction site to process or crush scrap or waste drywall to reduce the size of dry wall pieces before transporting the drywall off the construction site. The mobile drywall processor may include a container to capture the processed drywall. The container and the mobile drywall processor may be configured in size and shape for easy transportation to and from construction sites, including building interiors. Processed drywall is transported to be recycled or to a landfill. The processed or crushed drywall may have a higher density, reducing shipping and transportation costs.

### PRIORITY APPLICATION

This application claims priority to U.S. Provisional Patent Application No. 63/365,440, filed May 27, 2022, which is incorporated herein by reference. Any and all applications for which a foreign or domestic priority claim is identified in the Application Data Sheet as filed with the present application are hereby incorporated by reference under 37 CFR 1.57.

### BACKGROUND

### Field

Embodiments of the present disclosure relate to methods, devices, and systems for processing scrap drywall or other types of construction waste. More particularly, some embodiments relate to methods, devices, and systems for on-site processing of scrap drywall or other construction waste to facilitate the removal, transportation, disposal, and/or recycling thereof.

### Description

In residential and commercial construction, drywall is a commonly used building material. The drywall is supplied as large rectangular sheets which are cut to size during installation, producing scrap pieces that are too small or irregularly shaped to be used. During renovation projects, old drywall may be removed and replaced with new drywall. During demolition projects, old drywall is removed. Thus, scrap drywall is produced during construction, renovation, and demolition. Such scrap drywall must be removed from the jobsite and disposed of, either by sending to a landfill or by recycling. Current estimates indicate that drywall accounts for over two million tons of waste annually.

### SUMMARY

As discussed above, during various construction projects, scrap drywall is produced that must be removed from the jobsite. By its very nature, scrap drywall typically comprises irregularly shaped pieces of various sizes. Currently, handling of the irregularly shaped pieces (e.g., during removal from a jobsite and/or transportation to a disposal or recycling facility) is costly and inefficient. This is because the irregularly shaped pieces cannot be efficiently packed creating voids between the pieces that take up space in transportation containers or trucks.

Such scrap drywall is typically processed offsite at large industrial crushers or processing plants. The drywall must be transported from the construction site to the offsite crusher or processing plant before the drywall can be transported to a recycling plant or landfill. The multiple stops and significant transportation time increase the amount of time the drywall is exposed to the environment, increasing the probability of pollution sludge or contamination. Drywall that is contaminated may not be recycled and may be harmful to the environment. Therefore, a need exists for a method and system for processing drywall at a construction site and efficiently recycling the drywall.

Processing drywall at a worksite with a mobile drywall processor using the method of the present application may provide advantages over processing drywall off site. The mobile drywall processor may reduce a bulk volume of the drywall such that it can be more efficiently handled and transported. When drywall is transported from a worksite in large unprocessed pieces, the pieces of drywall may be irregular, and a large amount of the volume in a container or truck may be voids in between the pieces of drywall.

By processing the pieces of drywall into small pieces of drywall at the worksite a volume of voids between the pieces of drywall may be significantly reduced. Therefore, more drywall can be transported from the worksite more efficiently, or in other words, the volume needed to transport drywall from a worksite may be reduced. Processing pieces of drywall at a construction site will reduce transportation and labor costs associated with the handling of drywall.

In some aspects, a method of drywall recycling can include the steps of bringing a mobile drywall processor to a worksite, processing drywall with the mobile drywall processor at the worksite, collecting processed drywall in a container, and transporting the processed drywall from the worksite in the container.

In some aspects, a system for drywall recycling can include a mobile drywall processor including a feeder, a crusher, and a removable container, wherein the mobile drywall processor and container are configured to fit through a doorway and/or in an elevator, and wherein the mobile drywall processor is configured to crush drywall at a worksite, and the mobile container is configured to transport crushed drywall from the worksite to transportation.

In another aspect, a drywall processor device can include a base configured to receive a container that receives drywall that has been processed by the drywall processor device, the base further comprising a plurality of wheels that facilitate movement of the drywall processor device, and a drywall crusher assembly coupled to and supported by the base. The drywall crusher assembly can include a feed chute comprising an opening configured to receive pieces of scrap drywall to be processed by the drywall processor device, the feed chute extending along a vertical axis, an electric motor, a drive shaft configured to be rotatably driven by the electric motor, and one or more hammers fixedly coupled to the drive shaft such that the hammers rotate with the drive shaft when driven by the electric motors, the one or more hammers positioned such that, during at least a portion of the rotation of the drive shaft, the one or more hammers pass below an outlet of the feed chute so as that the one or more hammers contact the pieces of scrap drywall received at the feed chute to break the pieces of scrap drywall into smaller pieces, thereby reducing a bulk volume of the pieces of scrap drywall.

The drywall processor device can include one or more of the following features in any combination: (a) wherein an overall width of the device is less than 36 inches so that the drywall processor device can fit through a door frame; (b) wherein the opening of the feed chute is rectangular in shape having a width less than 3 inches; (c) wherein the one or more hammers are positioned at a vertical level no more than 6 inches below an outlet of the feed chute; (d) wherein the one or more hammers comprise four hammers extending radially outward from the drive shaft at 90-degree offsets with respect to each other; (e) wherein the electric motor is configured to operate using 120-volt AC; (f) wherein the electric motor comprises an output shaft that is rotationally coupled to the drive shaft through a belt and one or more pulleys; (g) wherein the base comprises an enclosure accessible through a door, and wherein the container is configured to be received within the door; (h) wherein the container is a 32-gallon trash can; (i) at least one sensor configured to detect a fill level of the container, and at least one indicator for indicating that the container is filled based on an output of the at least one sensor; (j) wherein the drywall processor device is configured to reduce the bulk volume of the pieces of scrap drywall by at least 20%; (k) wherein the drywall processor device is configured for transport to and use at a jobsite; and/or other features as described herein.

In another aspect, a method for processing scrap drywall at a jobsite is disclosed. The method can include providing a drywall processor device at the jobsite, wherein the drywall processor device is configured to crush scrap drywall thereby reducing a bulk volume of the scrap drywall, feeding pieces of scrap drywall into the drywall processor device at the jobsite, whereby the drywall processor devices crushes the pieces of scrap drywall and collects processed scrap drywall in a container, collecting the processed scrap drywall, and transporting the processed scrap drywall from the jobsite.

The method can include one or more of the following features in any combination: (a) wherein transporting the processed scrap drywall from the jobsite comprises transporting the processed scrap drywall directly to a disposal facility or a recycling facility; (b) wherein the processed scrap drywall is transported using trucks that deliver construction materials to the jobsite; (c) preprocessing the pieces of scrap drywall by manually cutting or breaking the pieces to a size that fits within a feed chute of the drywall processor device; (d) wherein providing the drywall processor device at the jobsite comprises moving the drywall processor device through one or more doors or up or down one or more elevator; (e) wherein an overall width of the drywall processor device is less than 36 inches so that the drywall processor device can fit through a door frame; (f) wherein the bulk volume of the scrap drywall is reduced by at least 20%; and/or other features as described herein.

### BRIEF DESCRIPTION OF THE DRAWINGS

The features and advantages of the systems, devices, and methods for on-site processing of scrap drywall or other construction waste described herein will become apparent from the following description, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. The drawings may not be drawn to scale.

FIG. 1 is a perspective view of an embodiment of a drywall processor device.

FIG. 2 is a front view of the drywall processor device.

FIG. 3 is a cross-sectional view of the drywall processor device taken along the line indicated in FIG. 2 illustrating some internal features of the drywall processor device according to an embodiment.

FIG. 4 is a top view of the drywall processor device.

FIG. 5 is a side view of an embodiment of a drywall crusher assembly of the drywall processor device of FIG. 1.

FIG. 6 illustrates a top view of the drywall crusher assembly of FIG. 5.

FIG. 7 illustrates a first cross-sectional view of the drywall crusher assembly taken along the line indicated in FIG. 5 and illustrating a hammer unit of the drywall crusher assembly according to an embodiment.

FIG. 8 illustrates a second cross-sectional view of the drywall crusher assembly taken along the line indicated in FIG. 5 and illustrate an embodiment of a support structure of the drywall crusher assembly according to an embodiment.

FIG. 9 is a front view of another embodiment of a drywall processor device that includes a base configured as an open frame.

FIG. 10 is a side view of the drywall processor device of FIG. 9.

FIG. 11 is a flowchart illustrating an example method for processing scrap drywall at a jobsite using a drywall processor device.

FIG. 12 illustrates an example method for facilitating the transportation, recycling, and/or disposal of scrap drywall.

### DETAILED DESCRIPTION

This disclosure relates to the processing and recycling of construction waste, including drywall waste. Some embodiments relate to devices, systems, and methods for on-site processing of scrap drywall or other construction waste to facilitate the removal, transportation, and recycling thereof. For example, and as described herein, in some embodiments, a relatively small mobile crushing unit can be configured to be used within an interior space where drywall is being installed or demolished. The mobile crushing unit can be configured to process scrap drywall or other construction waste by crushing or otherwise reducing such waste to a powder (or otherwise less voluminous state) that can be removed from the building and disposed of or recycled more efficiently.

Use of such a mobile crushing unit advantageously allows for waste drywall to be crushed at the work location, which can greatly reduce its volume and facilitate the removal and transportation thereof. The advantages are evident when compared with typical removal of scrap drywall from a construction site, which generally involves the removal and transportation of many odd size, irregularly shaped pieces of scrap drywall. Such scrap drywall is generally moved from the interior of a building to a disposal vehicle (e.g., a truck or a dumpster) for further processing and/or separation at a transfer facility. By crushing the scrap or waste drywall, the volume of material can be significantly reduced (in some instances, by as much as 50%). This reduction in volume can reduce the labor required to move debris from the building. Further, by processing the waste or scrap drywall at the source, recycling possibilities can be improved (for example, because waste drywall can be separated in situ), and the number of truck loads required to remove or transport the debris and the space necessary in landfills can also be reduced.

In residential and commercial industries, drywall, such as gypsum board, is an extensively used building material. Generally, it is supplied in the form of large rectangular sheets which the builder cuts to size depending upon the particular project. Cal Recycle estimates that, of the 15 million tons of gypsum board produced in the United States annually, 12% (1.8 million tons) is wasted during installation (e.g., in the form of scrap). Further, Cal Recycle estimates that another 675,000 tons of waste drywall is generated during demolition or renovation.

The handling of the scrap pieces of drywall that are generated during installation and the waste pieces of drywall that are generated during interior demolition requires an enormous expenditure of labor to get the pieces out of the building. In residential work, the waste material is either carried out of the building by hand or dropped down a chute into dumpsters. In commercial and high-rise work, the waste pieces are dumped into mini containers and then staged at an elevator or hoist, transported down to ground floor, staged, and then loaded into garbage trucks, which pack and crush the irregularly sized pieces. This handling of irregularly sized pieces is wasteful and costly on multiple levels, from the labor required to collect and carry the waste pieces, the movement to the truck or dumpster, the inefficient filling of the truck or dumpster which then travels to a transfer station where the waste is usually reduced and reloaded into trucks for transfer to a waste or recycling facility. However, even when the material is recycled, the irregularly sized or waste pieces are handled many times between the job site and the recycling station.

The devices, systems, and methods for on-site processing of scrap drywall can resolve or reduce many of the problems noted above. For example, by processing the scrap drywall on-site, the removal, transportation, and recycling thereof can be simplified or made more efficient. For example, on-site processing can include the use of a mobile crushing device or system that reduces the scrap drywall into granular (e.g., powder-like) sized pieces that can be consolidated into bags, drums, or other containers that can be filled and transported to a waste or recycling facility. By processing the material on-site, the overall volume of material can be reduced and consolidated into containers that can require less handling.

Further, in some embodiments, the resultant waste can be “cleaner,” which can improve recycling opportunities. This can be because waste is separated in-situ. Further, as the recycling of drywall matures (for example, as enabled by the systems and methods described herein), the trucks that now deliver new drywall to construction sites can be backloaded with waste drywall that has been processed at the construction site, further reducing the amount of trucking required to build buildings. Typically, trucks delivering drywall return completely empty.

Accordingly, an objective of the present disclosure is to provide new and/or improved methods for reducing the drywall waste stream to a more efficient process. Some implementations utilize on-site drywall crushers. A further objective is to create more opportunities to recycle the millions of tons of waste drywall disposed of every year.

These and other features of the methods and systems for processing scrap drywall or other types of construction waste described herein will become more fully apparent from the following description of specific embodiments illustrated in the figures. These embodiments are intended to illustrate the principles of this disclosure, and this disclosure should not be limited to merely the illustrated examples. The features of illustrated embodiments can be modified, combined, removed, and/or substituted as will be apparent to those of ordinary skill in the art upon consideration of the principles of this disclosure.

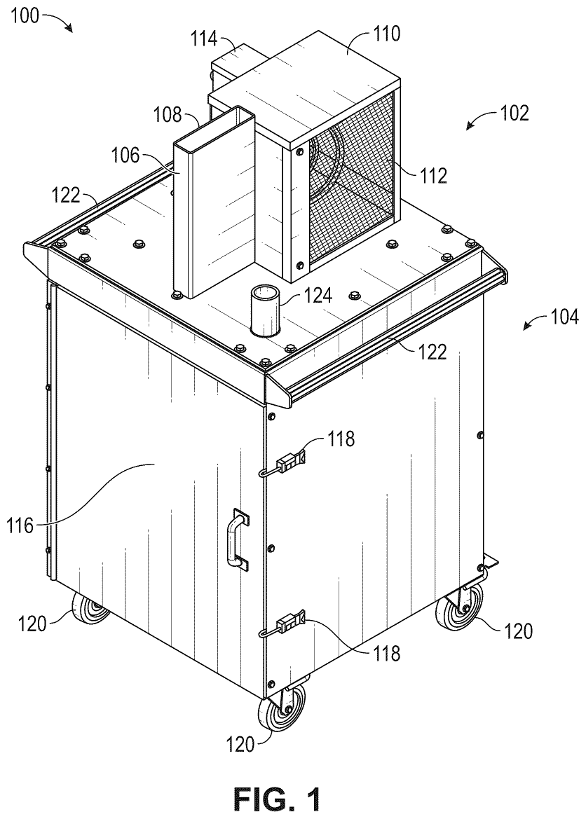

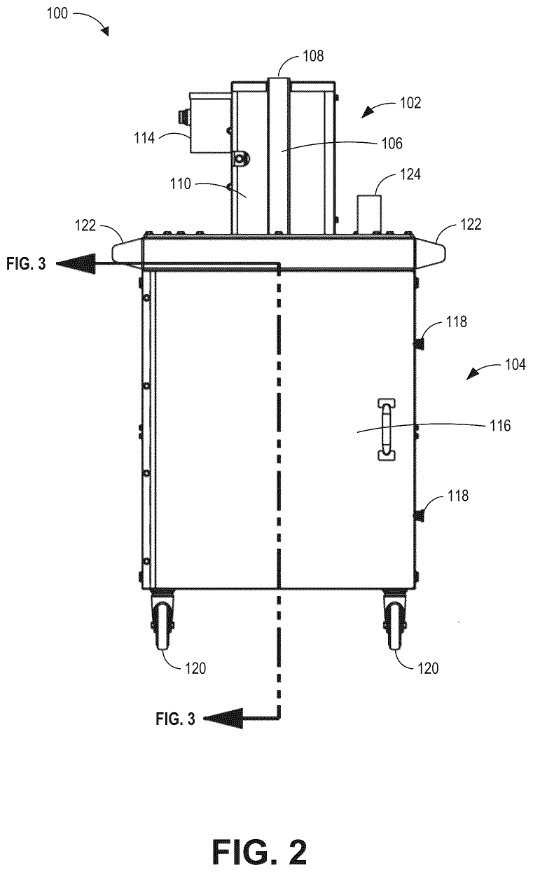

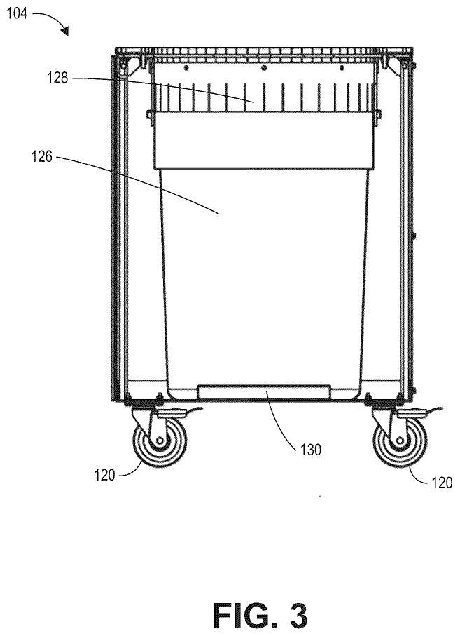

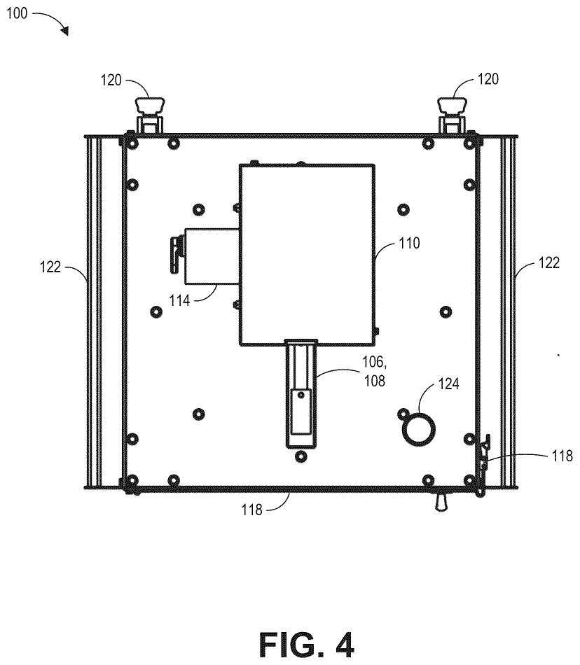

FIGS. 1-4 illustrate various views of an embodiment of a drywall processor device 100. In particular, FIG. 1 is a perspective view of the drywall processor device 100, and FIG. 2 is a front view of the drywall processor device 100. FIG. 3 is a cross-sectional view of the drywall processor device 100 taken along the line indicated in FIG. 2, and FIG. 4 is a top view of the drywall processor device 100. As will be described in more detail herein, the drywall processor device 100 is configured to process scrap drywall by crushing the scrap drywall such that it can be more efficiently stored, handled, and/or transported. Advantageously, the drywall processor device 100 is configured such that it can be transported to and used at a jobsite, thereby allowing scrap drywall to be at least initially processed at the first instance where the scrap drywall is produced. Such processing of scrap drywall in the first instance at the jobsite beneficially facilitates, and in some cases even eliminates, one or more downstream steps involved in the removal of scrap drywall for disposal and/or recycling.

As shown in FIG. 1, the drywall processor device 100 can include a drywall crusher assembly 102 and a base 104. The drywall crusher assembly 102 is configured to receive pieces of scrap drywall and process them by, for example, crushing them such that they can be more efficiently stored, handled, and transported. The term “crushing” is used throughout this application to refer to a process whereby pieces of scrap drywall are converted from larger, irregularly shaped pieces to smaller, more regularly shaped pieces. It should be noted, however, that the smaller, more regularly shaped pieces need not be uniform in size and shape. Rather, what is important is that the bulk storage volume of the scrap drywall is reduced as the smaller, more regularly shaped pieces generally occupy less volume than the larger, more irregularly shaped pieces by virtue of reducing voids between the pieces. Some voids, however, may and likely will be present in the processed material. Still, handling of the processed material will be greatly simplified. In some instances, the crushing processes described herein can reduce the bulk volume of the material by as much as 10%, as much as 20%, as much as 30%, as much as 40%, as much as 50%, as much as 60% as much as 70%, or more.

Drywall, which is also known as gypsum board or plasterboard, is a building material commonly used for interior walls and ceilings in residential and commercial construction. It is made from a core of gypsum sandwiched between two layers of paper or fiberglass. To recycle drywall, the paper or fiberglass material is treated differently than the gypsum material. Thus, it is advantageous to separate the fiberglass or paper from the gypsum. In some instances, the crushing processes described herein can separate (e.g., detach) at least 50%, at least 60%, at least 70%, at least 80%, or at least 90% of the fiberglass or paper from the gypsum.

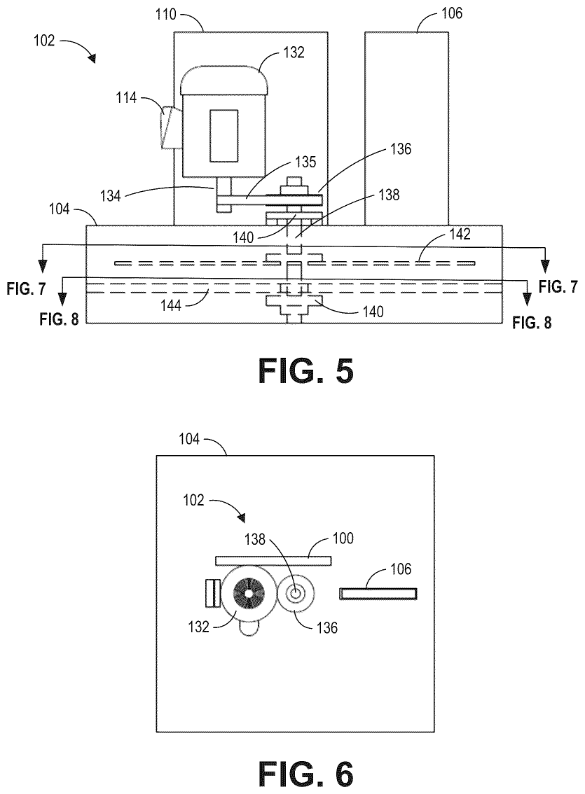

An embodiment of the drywall crusher assembly 102 is shown in FIGS. 5-8, which are described in more detail below. However, the drywall crusher assembly 102 will now be described generally with reference to FIGS. 1-4. As shown in FIG. 1, for example, the drywall crusher assembly 102 is positioned on the base 104. That is, the base 104 may support the drywall crusher assembly 102. In the illustrated embodiment, the drywall crusher assembly 102 is positioned directly over (i.e., on top of or above) the base 104. This configuration may be advantageous in that it allows the scrap drywall processed by the drywall crusher assembly 102 to fall, under the force of gravity, down into the base 104. Other configurations, however, are possible. For example, the drywall crusher assembly 102 can be positioned offset to the side of the base 104 and processed scrap drywall can be directed from the drywall crusher assembly 102 to the base 104 using one or more chutes or other conveying structures. Still, the configuration and position of the drywall crusher assembly 102 and the base 104 illustrated in FIG. 1 provides an advantageous form factor that both facilitates the use and portability of the drywall processor device 100.

As shown in FIG. 1, the drywall crusher assembly 102 includes a feed chute 106. The feed chute 106 is configured to receive the scrap drywall and to direct the received scrap drywall to a mechanism within the drywall crusher assembly 102 that crushes the material. In the illustrated embodiment, the feed chute 106 comprises a rectangular chute having an opening 108 into which pieces of drywall scrap are fed during use. The pieces of drywall scrap can be fed into the opening 108 of the feed chute 106 by hand, for example. In some embodiments, the pieces of drywall scrap are first processed by hand (e.g., by cutting and or breaking) such that the pieces can be fed into the opening 108.

As noted, in the illustrated embodiment, the feed chute 106 and corresponding opening 108 are rectangular in shape. The rectangular shape of the feed chute 106 and the opening 108 can have a length and a width. The width can be selected to accommodate the most common thicknesses of drywall. The most common drywall thickness is ½ inch, although drywall is also commonly available in other thicknesses such as ⅝ inch, ¼ inch, and ⅜ inch. Accordingly, the width of the feed chute 106 and the opening 108 should be at least ⅝ inch, although it is desirable to provide additional clearance to facilitate insertion of the material into the opening 108 and to prevent or reduce binding of the material within the feed chute 106. Accordingly, in some embodiments, the width of the feed chute 106 and opening 108 can be at least ¾ inch, 1 inch, 1 and ¼ inches, 1 and ½ inches, 1 and ¾ inches, 2 inches, 2 and ¼ inches, 2 and ½ inches, 2 and ¾ inches, 3 inches, or greater. However, in some instances, is desirable to limit the overall width of the feed chute 106 and opening 108 so that the feed chute 106 provides a structure for orienting the pieces of scrap drywall passing there through relative to the crushing mechanism. Accordingly, in some embodiments, the width of the feed chute 106 and the opening 108 is no more than 1 inch, 1 and ¼ inches, 1 and ½ inches, 1 and ¾ inches, 2 inches, 2 and ¼ inches, 2 and ½ inches, 2 and ¾ inches, or 3 inches. In other terms, in some embodiments, the width of the feed chute 106 and the opening 108 can be configured to provide about ½ inch, ¾ inch, 1 inch, 1 and ¼ inches, 1 and ½ inches, 1 and ¾ inches, 2 inches, 2 and ¼ inches, or 2 and ½ inches of clearance relative to the anticipated maximum thickness of the material that is to be fed into the drywall processor device 100.

Various lengths for the feed chute 106 and the opening 108 are possible. For example, in some embodiments, the length of the feed chute 106 and the opening 108 can be 2 inches, 4 inches, 6 inches, 8 inches, 10 inches, 12 inches, 14 inches, 16 inches, 18 inches or greater as well as other lengths between the listed values. The length of the feed chute 106 and the opening 108 can advantageously be maximized to reduce the amount of preprocessing of the material that is necessary before feeding the material into the drywall processor device 100, while also considering the impact that larger pieces of material will have on the crusher mechanism.

As shown in FIG. 1, in the illustrated embodiment, the feed chute 106 extends in a generally vertical direction upward from the base 104. This configuration advantageously allows the material inserted through the opening 108 to fall into the crusher mechanism under the force of gravity. Further, through testing, it has been determined by the inventor of this application, that this configuration with a vertically oriented feed chute 106 improves the efficiency of the drywall processor device 100 thereby allowing the drywall processor device 100 to process material more efficiently and/or more quickly. It is believed that the vertical orientation of the feed chute 106 advantageously orients the inserted material relative to hammers (described below, see FIGS. 5 and 8) of the drywall crusher assembly 102. For example, it is believed that this orientation causes the hammers to impact the side or face of the inserted material rather than the end of the inserted material, resulting in increased crushing efficiency. Further, the hammers impacting the material in this way may cause the material to shear against an end of the feed chute 106.

While testing has determined that certain advantages are associated with orienting the feed chute 106 in a vertical orientation, other orientations for the feed chute 106 are also possible. For example, the feed chute 106 can be oriented at an angle with respect to vertical so that the material inserted in the feed chute 106 slides down an internal wall of the feed chute 106 as it is directed to the crushing mechanism.

Various heights for the feed chute 106 are possible. For example, the feed chute 106 can be at least 6 inches, 8 inches, 12 inches, 14 inches, 16 inches, 18 inches or higher, as well as other heights between the listed values. It is noted that the height of the feed chute 106 should be sufficient for safe operation of the device as it separates the opening 108 from the crushing mechanism at the opposite end of the feed chute 106.

In some embodiments, a funnel or other device which increases the size of the opening 108 relative to the feed chute 106 can be included at the opening 108 to facilitate insertion of the pieces of material into the feed chute 106.

As illustrated in FIG. 1, the drywall crusher assembly 102 of the drywall processor device 100 can also include a housing 110 that is configured to enclose various electrical and/or mechanical components of the drywall crusher assembly 102. For example, the housing 110 can cover and enclose components that drive the crusher mechanism. Examples of such components can include, for example, one or more of a motor, a transmission, and control circuitry. Examples of some of these components will be described in more detail below with reference to the embodiment of the drywall crusher assembly 102 shown in FIGS. 5-8. In the illustrated embodiment, the housing 110 includes a grate 112 on one side thereof. The grate 112 can be configured to provide cooling to the components within the housing 110.

In the illustrated embodiment, the housing includes a control panel or control box 114 positioned thereon. The control box 114 can include one or more user inputs or controls for controlling operation of the drywall processor device 100. For example, the control box 114 can include user inputs that allow a user to start and/or stop the crushing mechanism. In some embodiments, the control box 114 can also include a user input to allow a user to adjust a speed associated with the crushing mechanism. Other types of control inputs can also be provided. Although the control box 114 is positioned on the housing 110 in the illustrated embodiment, other positions for the control box 114 are also possible.

With continued reference to FIG. 1, in the illustrated embodiment, the base 104 supports the drywall crusher assembly 102. In addition to providing support for the drywall crusher assembly 102, the base 104 can also be configured to receive and/or collect the material that has been processed by the drywall crusher assembly 102. As shown in FIG. 1, in the illustrated embodiment, the base 104 can comprise an enclosure formed from one or more walls. An interior of the enclosure can be accessible through a door 116. The door 116 can include one or more latches 118, for securing the door 116 in the closed position.

In some embodiments, the door 116 is configured with a sensor or switch that detects when the door is in the closed position and operation of the drywall crusher assembly 102 is restricted to times only when the door 116 is closed. This can improve the safety of the drywall processor device 100 as it further prevents accidental contact between an operator and the crusher mechanism.

As shown in FIG. 1, the base 104 can further include one or more wheels, such as the casters 120 shown in the figures. In the illustrated embodiment, four casters 120 are included, with one caster 120 at each bottom corner of the base 104. The wheels are configured to permit and facilitate portability of the drywall processor device 100. As discussed herein, a particular advantage to the drywall processor device 100 is that the device is portable so that it can be transported to and used at a jobsite where the scrap drywall is created. In some embodiments, such as the illustrated embodiment, the wheels can comprise casters 120 which include locks, such that, once the drywall processor device 100 is positioned as desired, the casters 120 can be locked to prevent unintended motion and provide stability during operation of the drywall processor device 100.

To further facilitate the portability of the drywall processor device 100, the drywall processor device 100 can include one or more handles 122. In the illustrated embodiment, the drywall processor device 100 includes two handles 122, with each positioned on an opposite side of the base 104. In other embodiments, greater or fewer numbers of handles 122 can be used, and such handles can be provided at different positions. It should be noted that advantageous positions for the one or more handles 122 include positions that limit the overall width of the drywall processor device 100 such that the drywall processor device 100 can fit through doors so as to be easily transported to a jobsite. Example widths (and other overall dimensions) of the drywall processor device 100 are described further below.

The drywall processor device 100 can include a port 124 configured to allow connection to a dust collection system. In the illustrated embodiment, the port 124 is positioned on a top surface of the base 104, although other positions for the port 124 are also possible. In some embodiments, for example, as illustrated, the port 124 comprises a 2 and ½ inch vacuum connection port. Such port can be configured to connect to a dust collection bag (not shown) or to a hose of a shop vac, which can be used for dust collection. Other dust collection systems can also be used.

A cross-sectional view of the base 104 is shown in FIG. 3. The cross-sectional view of FIG. 3 is taken along the line illustrated in FIG. 2 and permits visualization of some internal features of the drywall processor device 100 within the base 104. The view of FIG. 3 is also similar to the view into the interior of the base 104 if the door 116 is open. As shown in FIG. 3, the interior of the base 104 can be configured to receive a container 126 that is positioned below the crusher mechanism to receive the processed material. In the illustrated embodiment, the container 126 comprises a standard 32-gallon trash can. It is believed that this size provides a balance between the amount of processed material that can be held within the drywall processor device 100 while still remaining light enough to be handleable. Other types of containers can also be used, such as other sizes of garbage cans and/or debris bags. If a non-rigid container is used, such as a debris bag, the interior of the base 104 can be provided with hooks or other structures configured to secure and orient the container.

With continued reference to FIG. 3, the drywall processor device 100 can include a shroud 128. The shroud 128 can be configured to at least partially surround and/or limit access to the crusher mechanism and/or to direct processed material from the crusher mechanism into the container 126. In the illustrated embodiment, the shroud 128 comprises a flexible curtain. The flexible curtain includes one or more slits such that a lower edge of the flexible curtain is formed as one or more strips. In some embodiments, when the container 126 is positioned in the base 104, the container 126 and the shroud 128 limit access to the crusher mechanism to improve the safety of the device. Further, to this end, in some embodiments, the drywall processor device 100 can include one or more sensors that detect whether the container 126 is installed and restrict operation of the drywall processor device 100 to times only when the container 126 is installed.

FIG. 3 also illustrates that, for some embodiments, the base 104 may include an opening or vent 130 positioned along a lower edge of the base 104. The vent 130 can be used, for example, to clean the interior of the base 104 in case not all processed material is collected in the container 126.

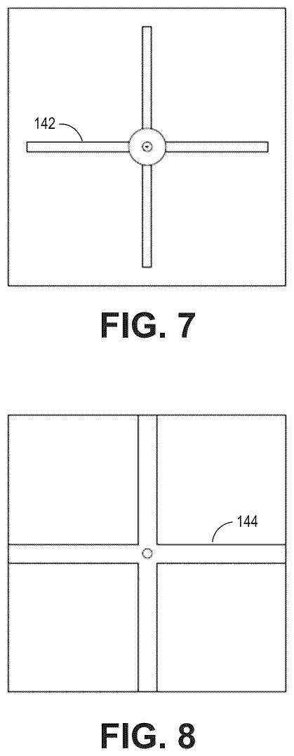

Turning now to FIGS. 5-8, an example crusher mechanism for the drywall processor device 100 is illustrated in the more detailed views. In these figures, FIG. 5 is a side view, and FIG. 6 is a top view of the drywall crusher assembly 102. FIGS. 7 and 8 are cross-sectional views of the drywall crusher assembly 102 taken along lines illustrated in FIG. 5. The drywall crusher assembly 102 can include components configured to crush or otherwise process scrap drywall to reduce its bulk storage volume to facilitate handling, transport, disposal, and or recycling thereof. As noted above, the drywall crusher assembly 102 is carried on drywall processor device 100 so that such processing can be completed using a relatively small and portable machine that can be used directly at a jobsite, for example, in the first instance where scrap drywall is created.

Although FIGS. 5-8 illustrate one example drywall crusher assembly 102, other mechanical structures for crushing and/or processing the scrap drywall are possible. In some embodiments, the drywall crusher assembly 102 comprises a hammermill. For example, a hammermill can comprise a rotor with one or more hammers attached to, which when rotated at sufficient speed, are brought into contact with the scrap drywall to crush or otherwise process it.

As shown in FIGS. 5-8, in the illustrated embodiment, the drywall crusher assembly 102 comprises various components. The components of the drywall crusher assembly 102 can be mounted on or otherwise carried or supported by the base 104 of the drywall processor device 100. Some of the components may be disposed within the housing 110, which is shown in FIG. 1 and described above. For ease of visualization of such components, in FIGS. 5 and 6, only one wall of the housing 110 is illustrated.

As shown, the drywall crusher assembly 102 can comprise an electric motor 132, an output shaft 134, a pulley 136, a drive shaft 138, one or more bearings 140, one or more hammers 142, and a support bracket 144. In general, the electric motor 132 is configured to cause rotation of the hammers 142. The hammers 142 are positioned such that, during at least a portion of their rotation, the hammers 142 contact material that is received through the feed chute 106. When the hammers 142 contact the material, they break the material into smaller pieces. The processed material then continues to fall into the container 126 (see FIG. 3) positioned below.

In the illustrated embodiment, the electric motor 132 is positioned within the housing 110. The electric motor 132 includes an output shaft 134 which is rotated as the electric motor 132 is operated. In the example of the figures, the electric motor 132 is oriented such that the output shaft 134 extends vertically downward, below the body of the electric motor 132. Other configurations and orientations are possible. In some embodiments, the electric motor 132 can be an AC (alternating current) electric motor. The electric motor 132 can be configured or selected such that it is operated with voltages that are commonly available at jobsites, such as 120 volts AC, such as is common in the United States, or 230 volts AC, such as is common in Europe or Asia, for example. Operating the electric motor 132 with such commonly available voltages is again advantageous because it allows the use of the drywall processor device 100 without requiring specialized, less commonly available power sources such as 240-volt AC power. However, in some embodiments, the electric motor 132 can be configured to use these less common voltages.

In some embodiments, the electric motor 132 can be a DC (direct current) electric motor. In such embodiments, the electric motor 132 can be driven by battery power, and one or more batteries can be included in or on the drywall processor device 100. In some embodiments, separate battery power (e.g., batteries not on the drywall processor device 100) can be used. Use of DC power and batteries can allow the drywall processor device 100 to be used in places where outlets are not available.

In some embodiments, the electric motor 132 can be replaced with a non-electric motor, such as, for example, a gas-powered motor or internal combustion engine. In such cases, the motor can be supplied with fuel, which can be carried in tanks that can be provided on the drywall processor device 100 or separately.

In any event, the electric motor 132 is used to drive the drywall crusher assembly 102. One or more controls, for example, as discussed above, can be provided on the control box 114 for controlling operation of the electric motor 132. Such controls can include, for example, on, off, and/or speed control, among others.

In the illustrated configuration, the output shaft 134 of the electric motor 132 is indirectly coupled to a drive shaft 138. As shown in FIGS. 5 and 6, the drive shaft 138 can be positioned to extend in a vertical direction (see FIG. 5) generally or substantially at the center point of the drywall processor device 100 when viewed from above (see FIG. 6). This orientation can advantageously balance the drywall processor device 100 reducing vibration and noise, for example. In the illustrated configuration, the output shaft 134 is supported on bearings 140. Two bearings 140 are illustrated, but other numbers of bearings and alternative positions can be used. In the illustrated example, a first bearing 140 is positioned on a top surface of the base 104, and a second bearing 140 is carried on a support bracket 144 (see FIG. 8) positioned within the interior of the base 104. As shown in the example of FIG. 8, the support bracket 144 can be configured with a “t” or “x” shape, although other configurations are also possible. It is important, however, that the configuration of the support bracket 144 does not substantially interfere with the ability of processed material to fall through the device into the container 126 below. In some embodiments, the support bracket 144 can be omitted entirely.

The drive shaft 138 can be coupled to the output shaft 134 by various mechanisms, such as belts, chains, gears, etc. In other embodiments, the output shaft 134 and the drive shaft 138 can be directly connected or coextensive, such that the electric motor 132 drives the drive shaft 138 directly or are one and the same. Use of an indirect coupling method (e.g., with belts, chains, gears, or other transmission mechanisms) may advantageously allow for creation of a gear ratio between the output shaft 134 and the drive shaft 138 that can be configured to adjust the speed or torque of the drive shaft 138. In the illustrated embodiment, a pulley 136 is carried on the drive shaft 138. A belt 135 is carried on the pulley 136 and the output shaft 134 rotationally coupling the two together. Although not shown, in some embodiments, an additional pulley can be coupled to the output shaft 134 and the belt 135 can be mounted on that pulley as well. Thus, via the belt 135 and the pulley(s) 136, rotation of the output shaft 134 is coupled to the drive shaft 138, thereby allowing the electric motor 132 to drive the drive shaft 138.

As shown in FIGS. 5 and 7, one or more hammers 142 are coupled to the drive shaft 138. The hammers 142 can be fixedly coupled to the drive shaft 138 such that the hammers 142 rotate with the drive shaft 138 and are thus driven by the electric motor 132. Also, as shown in FIG. 5, the hammers 142 extend (at least during a portion of their rotation) below an outlet of the feed chute 106 such that material passing through the feed chute 106 is contacted by the rotating hammers 142.

As best seen in FIG. 7, in the illustrated embodiment, four hammers 142 are provided. The four hammers 142 are arranged in a “t” or “x” shape, at 90-degree intervals around the drive shaft 138. Other configurations, including other numbers of hammers 142 are also possible. Further, although the illustrated example includes all hammers 142 arranged at a single vertical level, in other embodiments, multiples levels or layers of hammers 142 can be provided. For example, a first set of one or more hammers 142 can be coupled to the drive shaft 138 at a first vertical level, and a second set of one or more hammers 142 can be coupled to the drive shaft 138 at a second vertical level. One, two, three, four, or more sets of hammers 142 can be provided. When multiple layers of one or more hammers 142 are provided, the hammers 142 can be rotationally aligned or rotationally offset with respect to one another.

The hammers 142 can comprise various shapes. In the illustrated embodiment, the hammers 142 comprise rectangular bars having a thickness (in the vertical direction), which is less than a width (in a horizontal direction). Other configurations are possible, including bars having a thickness greater than a width or equal thickness and width. In the illustrated embodiment, a leading edge (e.g., the edge intended to contact the material during use) is flat and/or blunt. This need not be the case in all embodiments. In some embodiments, the leading edge is sharpened, such that the hammers 142 can be considered blades.

The hammers 142 can be positioned, in a vertical direction, to be in proximity to the outlet of the feed chute 106. For example, in some embodiments, the hammers 142 (or the most vertical layer of hammers 142) is less than 2 inches, less than 4 inches, less than 6 inches, or less than 8 inches from the outlet of the feed chute 106 (measured in the vertical direction). As discussed above, during testing performed by the inventor of this application, this configuration with hammers 142 rotating in proximity below the outlet of the feed chute 106 improves the efficiency of the drywall processor device 100 thereby allowing the drywall processor device 100 to process material more efficiently and/or more quickly. For example, it is believed that this orientation causes the hammers 142 to impact the side or face of the inserted material rather than the end of the inserted material, resulting in increased crushing efficiency. Further, the hammers 142 impacting the material in this way may cause the material to shear against an end of the feed chute 106.

As discussed throughout this application, the drywall processor device 100 can be configured in size and shape so as to be relatively portable so that the drywall processor device 100 can be moved to and used at a jobsite. In this manner, drywall scap can be processed at the site where the scrap is produced. For example, off cuts of drywall produced during installation can be processed on site, and any drywall removed during a renovation or demolition process can be processed on site.

To this end, the overall dimensions of the drywall processor device 100 can be configured such that the drywall processor device 100 can fit through most doors. Similarly, the overall dimensions of the drywall processor device 100 can be configured such that the drywall processor device 100 can fit into elevators. This allows the drywall processor device 100 to be easily brought to the locations where it is needed.

For example, in some embodiments, the maximum width of the drywall processor device 100, measured in the horizontal direction, can be less than 48 inches, less than 46 inches, less than 44 inches, less than 42 inches, less than 40 inches, less than 38 inches, less than 36 inches, less than 34 inches, less than 32 inches, less than 30 inches, less than 28 inches, or less than 24 inches, although this need not be the case in all embodiments. In some embodiments, the drywall processor device 100 is generally square in shape, with substantially equal length and width in orthogonally oriented horizontal directions, but this need not be the case in all embodiments. In some embodiments, the length is greater than the width. In some embodiments, the drywall processor device 100 can have an overall height (measured vertically) that is less than 80 inches, less than 78 inches, less than 76 inches, less than 74 inches, less than 72 inches, less than 70 inches, less than 68 inches, less than 66 inches, less than 64 inches, less than 62 inches, less than 60 inches, less than 58 inches, less than 56 inches, less than 54 inches, less than 52 inches, less than 50 inches, less than 48 inches, less than 46 inches, less than 44 inches, less than 42 inches, less than 40 inches, less than 38 inches, or less than 36 inches, although this need not be the case in all embodiments.

To increase portability of the drywall processor device 100, in some embodiments, the weight (when empty) can be limited to less than 500 pounds, less than 475 pounds, less than 450 pounds, less than 425 pounds, less than 400 pounds, less than 375 pounds, less than 350 pounds, less than 325 pounds, less than 300 pounds, less than 275 pounds, less than 250 pounds, less than 225 pounds, less than 200 pounds, less than 175 pounds, less than 150 pounds, or less, although this need not be the case in all embodiments.

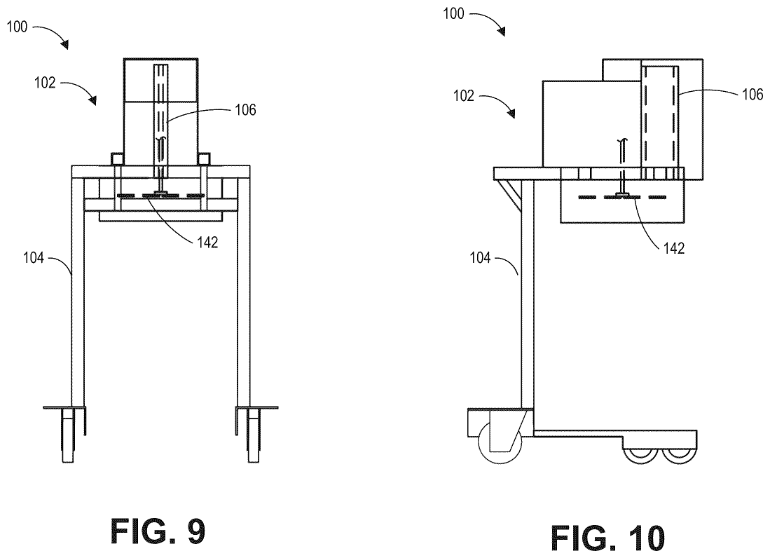

In the illustrated embodiment of FIGS. 1-8, the drywall processor device 100 includes an enclosed base 104. This need not be the case in all embodiments. For example, the enclosed base 104 can be configured as an open frame configured to rest on the ground and extend over and possibly support the container 126. An example drywall processor device 100 including base 104 configured as an open frame is shown in FIGS. 9 and 10, which illustrate front and side views thereof. Other configurations for an open frame base 104 are also possible.

In some embodiments of the drywall processor device 100, which can include some embodiments of the drywall processor device 100 of FIGS. 1-8 and some embodiments of the drywall processor device 100 of FIGS. 9 and 10, a grate or screen can be provided below the hammers 142 to prevent accidental contact between an operator and the hammers 142. The grate should be configured, however, to not inhibit processed material from passing therethrough and falling into the container 126.

In some embodiments, the drywall processor device 100 can include one or more sensors configured to detect a fill level of the processed material inside the container 126. For example, a weight sensor can be positioned to measure the weight of the container 126 and an approximate fill level can be determined therefrom. As another example, one or more laser-based sensors can be used to determine fill height. An output from these sensors can be used to generate an alarm or signal that can indicate to an operator that the container 126 must be emptied (e.g., into a larger construction dumpster, truck, etc.) or replaced with an empty container 126.

In some embodiments, the output from these sensors can also be used to determine how much material has been processed at the site. Such information can be communicated to a control system that can dispatch or schedule trucks to pick up the processed material from the jobsite.

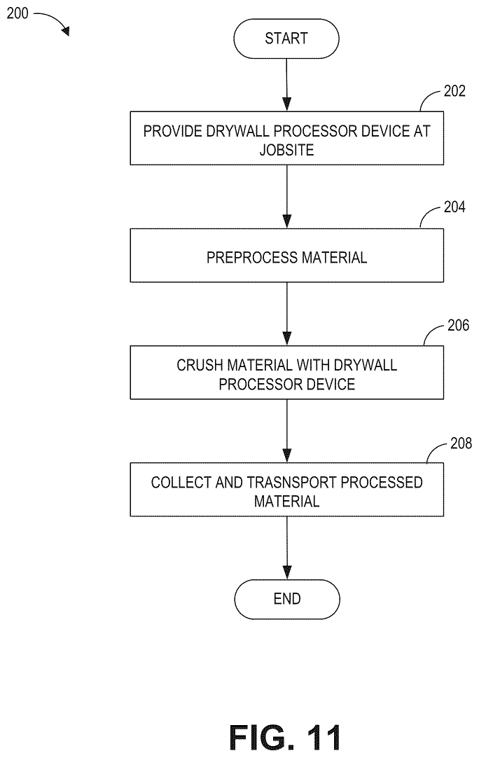

FIG. 11 is a flowchart illustrating an example method 200 for processing scrap drywall at a jobsite using a drywall processor device. The method 200 can be performed using, for example, the drywall processor device 100 described above. The method 200 begins at block 202. At block 202, the drywall processor device 100 is provided at a jobsite. This can include, for example, moving the drywall processor device 100 inside of a building, such as a residential or commercial building, undergoing construction, renovation, or demolition. As noted above, the drywall processor device 100 can be portable such that the drywall processor device 100 can be brought into close proximity to the location at which scrap drywall is produced. For example, in some instances, the drywall processor device 100 can be moved inside a building and/or onto a particular floor or level where work is occurring. This can include moving the drywall processor device 100 through one or more exterior and/or interior doors and up an elevator. The drywall processor device 100 can be powered using electricity provided at the jobsite, either through wall outlets, generators, or other sources. Alternatively, the device 100 can be powered by batteries or other fuel as described above.

At block 204, in some instances, it may be necessary to preprocess the material which will later be further processed using the drywall processor device 100. This can be the case where the scrap drywall is in pieces that are too large to be fed into the feed chute 106 of the drywall processor device 100. Preprocessing the material can include cutting and/or otherwise breaking the material into strips or pieces that are able to be fed into the feed chute 106. Such preprocessing can be performed manually.

At block 206, the material can then be processed or crushed using the drywall processor device 100. This can include feeding the material into the feed chute 106 such that it is processed or crushed and collected within the container 126. As needed, containers 126 can be replaced with empty containers and/or emptied into other larger containers, such as construction dumpsters. Notably, by processing the material with the drywall processor device 100 the bulk volume of the material is reduced such that the material is easier to handle or transport.

At block 208, the processed material can be collected at the jobsite and transported to another destination for disposal and or recycling. For example, the containers 126 can be loaded onto one or more trucks for delivery to the destination. As another example, the containers 126 can be emptied into other larger containers (such as construction dumpsters) that can be loaded onto trucks for transport. Notably, because the material has been processed by the drywall processor device 100, a number of trips required to move the scrap drywall from the jobsite to the truck and/or the number of trucks or trips required to transport the material to its destination can be reduced, thereby improving efficiency. The processed material can be transported to a landfill for disposal or to a recycling center for recycling.

The processed drywall can be sorted to remove any contaminants, such as nails, screws, or insulation materials. The processed material can further be processed to separate the paper or fiberglass from the gypsum core of the material. The separated gypsum can be processed into a fine powder and can be used to manufacture new drywall or as an ingredient in cement production or soil amendment. The paper or fiberglass coverings are usually recycled separately. The paper may be used for manufacturing new paper products, and the fiberglass can be recycled for insulation or other applications.

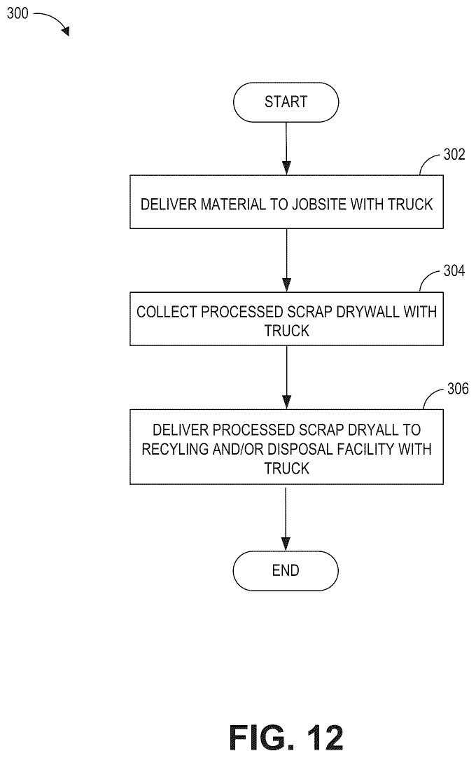

FIG. 12 illustrates an example method 300 for facilitating the transportation, recycling, and/or disposal of scrap drywall. Advantageously, this method uses the return trips of empty delivery trucks to transport processed scrap drywall to a recycling or disposal facility. At block 302, constructions materials are delivered to a jobsite by truck. This construction materials can include drywall or other construction materials. Typically, the unloaded trucks are then driven back to their origin in an empty state. However, in the method 300, processed scrap drywall—which has been processed by a drywall processor device 100—is collected from the jobsite at block 304 and loaded onto the truck. At block 306, that truck then delivered the processed scrap drywall to a recycling or disposal facility. In this way, the use of the trucks is maximized, providing beneficial service both on inbound routes to and outbound rounds from the job site.

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of drywall processing systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of drywall recycling systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above but should be determined only by a fair reading of the claims that follow as well as their full scope of equivalents.

What is claimed is:

1. A drywall processor device comprising:
a base configured to receive a container that receives drywall that has been processed by the drywall processor device, the base further comprising a plurality of wheels that facilitate movement of the drywall processor device; and
a drywall crusher assembly coupled to and supported by the base, the drywall crusher assembly comprising:
a feed chute comprising an opening configured to receive pieces of scrap drywall to be processed by the drywall processor device, the feed chute extending along a vertical axis;
an electric motor;
a drive shaft configured to be rotatably driven by the electric motor; and
one or more hammers fixedly coupled to the drive shaft such that the hammers rotate with the drive shaft when driven by the electric motors, the one or more hammers positioned such that, during at least a portion of the rotation of the drive shaft, the one or more hammers pass below an outlet of the feed chute so as that the one or more hammers contact the pieces of scrap drywall received at the feed chute to break the pieces of scrap drywall into smaller pieces, thereby reducing a bulk volume of the pieces of scrap drywall.

2. The drywall processor device of claim 1, wherein an overall width of the device is less than 36 inches so that the drywall processor device can fit through a door frame.

3. The drywall processor device of claim 1, wherein the opening of the feed chute is rectangular in shape having a width less than 3 inches.

4. The drywall processor device of claim 1, wherein the one or more hammers are positioned at a vertical level no more than 6 inches below an outlet of the feed chute.

5. The drywall processor device of claim 1, wherein the one or more hammers comprise four hammers extending radially outward from the drive shaft at 90-degree offsets with respect to each other.

6. The drywall processor device of claim 1, wherein the electric motor is configured to operate using 120-volt AC.

7. The drywall processor device of claim 1, wherein the electric motor comprises an output shaft that is rotationally coupled to the drive shaft through a belt and one or more pulleys.

8. The drywall processor device of claim 1, wherein the base comprises an enclosure accessible through a door, and wherein the container is configured to be received within the door.

9. The drywall processor device of claim 1, wherein the container is a 32-gallon trash can.

10. wall processor device of claim 1, further comprising at least one sensor configured to detect a fill level of the container, and at least one indicator for indicating that the container is filled based on an output of the at least one sensor.

11. The drywall processor device of claim 1, wherein the drywall processor device is configured to reduce the bulk volume of the pieces of scrap drywall by at least 20%.

12. The drywall processor device of claim 1, wherein the drywall processor device is configured for transport to and use at a jobsite.

13. A method for processing scrap drywall at a jobsite, the method comprising:
providing a drywall processor device at the jobsite, wherein the drywall processor device is configured to crush scrap drywall thereby reducing a bulk volume of the scrap drywall;
feeding pieces of scrap drywall into the drywall processor device at the jobsite, whereby the drywall processor devices crushes the pieces of scrap drywall and collects processed scrap drywall in a container;
collecting the processed scrap drywall; and
transporting the processed scrap drywall from the jobsite.

14. The method of claim 13, wherein transporting the processed scrap drywall from the jobsite comprises transporting the processed scrap drywall directly to a disposal facility or a recycling facility.

15. The method of claim 13, wherein the processed scrap drywall is transported using trucks that deliver construction materials to the jobsite.

16. The method of claim 13, further comprising:
preprocessing the pieces of scrap drywall by manually cutting or breaking the pieces to a size that fits within a feed chute of the drywall processor device.

17. The method of claim 13, wherein providing the drywall processor device at the jobsite comprises moving the drywall processor device through one or more doors or up or down one or more elevators.

18. The method of claim 13, wherein the drywall processor device comprises:
a base configured to receive a container that receives drywall that has been processed by the drywall processor device, the base further comprising a plurality of wheels that facilitate movement of the drywall processor device; and
a drywall crusher assembly coupled to and supported by the base, the drywall crusher assembly comprising:
a feed chute comprising an opening configured to receive pieces of scrap drywall to be processed by the drywall processor device, the feed chute extending along a vertical axis;
an electric motor;
a drive shaft configured to be rotatably driven by the electric motor; and
one or more hammers fixedly coupled to the drive shaft such that the hammers rotate with the drive shaft when driven by the electric motors, the one or more hammers positioned such that, during at least a portion of the rotation of the drive shaft, the one or more hammers pass below an outlet of the feed chute so as that the one or more hammers contact the pieces of scrap drywall received at the feed chute to break the pieces of scrap drywall into smaller pieces, thereby reducing the bulk volume of the pieces of scrap drywall.

19. The method of claim 18, wherein an overall width of the drywall processor device is less than 36 inches so that the drywall processor device can fit through a door frame.

20. The method of claim 13, wherein the bulk volume of the scrap drywall is reduced by at least 20%.
